(19) United States
(12) Patent Application Publication
(10) Pub. No.: US 2024/0354588 A1
(43) Pub. Date: Oct. 24, 2024

(54) SYSTEMS AND METHODS FOR GENERATING MODEL ARCHITECTURES FOR TASK-SPECIFIC MODELS IN ACCELERATED TRANSFER LEARNING

(71) Applicant: Microsoft Technology Licensing, LLC, Redmond, WA (US)

(72) Inventor: Jorge Alexandre SILVA TAVARES, Munich (DE)

(21) Appl. No.: 18/303,525

(22) Filed: Apr. 19, 2023

(51) Int. Cl. G06N 3/096; G06N 3/045

(52) U.S. Cl. CPC G06N 3/096; G06N 3/045

(57) ABSTRACT

A system for generating one or more task-specific machine learning models for use in conjunction with one or more accelerated machine learning models is configurable to (i) identify a selected search space from a plurality of pre-defined search spaces; (ii) determine a set of candidate model architectures from the selected search space utilizing model architecture search; (iii) train a set of task-specific machine learning models based upon the set of candidate model architectures using a set of training data comprising input data comprising at least a set of embeddings generated by one or more accelerated machine learning models and task-specific ground truth output; and (iv) output one or more task-specific machine learning models from the set of task-specific machine learning models based upon an evaluation of performance of each task-specific machine learning model.

### BACKGROUND

Machine learning solutions have been developed and applied to different problems and tasks in various industries. Deep neural architectures have received significant attention in research and commercial domains. Many users and/or customers obtain task-specific deep neural architectures by fine-tuning an existing deep neural architecture. For instance, a customer can fine-tune a base neural language representation (NLR), such as BERT (bidirectional encoder representations from transformers), using domain-specific training data to obtain a task- or domain-specific NLR.

Many base models that are fine-tuned to provide task- or domain-specific models to users and/or customers are large and/or complex. As a result, task- or domain-specific models that are obtained using base models are computationally intensive to train or fine-tune. After training/fine-tuning, such task- or domain-specific models are also computationally intensive to perform inference with. Customers/users often lack sufficient resources (e.g., GPU resources) to efficiently train or run such task- or domain-specific models. This challenge is compounded for customers/users that utilize multiple task- or domain-specific models that are fine-tuned from large base models.

The subject matter claimed herein is not limited to embodiments that operate only in environments such as those described above. Rather, this background is only provided to illustrate one example technology area where some embodiments described herein may be practiced.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered limiting in scope, embodiments will be described and explained with additional specificity and detail through the use of the accompanying drawings in which:

FIG. 1 illustrates example components of an example system that may include or be used to implement one or more disclosed embodiments.

FIG. 2 depicts example search spaces that may be utilized to perform neural architecture search to generate candidate model architectures for task-specific models in accelerated transfer learning.

FIG. 3A depicts a conceptual representation of utilizing neural architecture search to generate candidate model architectures for task-specific models in accelerated transfer learning.

FIG. 3B depicts a conceptual representation of using at least some of the candidate model architectures to train candidate task-specific models for accelerated transfer learning.

FIG. 3C depicts a conceptual representation of determining one or more output task-specific models for accelerated transfer learning based upon performance evaluation of candidate task-specific models.

FIG. 4 depicts a conceptual representation of the operation of a task-specific model in conjunction with an accelerated model to generate output.

FIG. 5 illustrates an example flow diagram depicting acts associated with generating one or more task-specific machine learning models for use in conjunction with one or more accelerated machine learning models.

FIG. 6 illustrates an example flow diagram depicting acts associated with generating a set of model architectures for a task-specific machine learning model for use in conjunction with an accelerated machine learning model.

### DETAILED DESCRIPTION

Disclosed embodiments are generally directed to systems and methods for generating model architectures for task-specific models in accelerated transfer learning. As used herein, “task-specific” indicates a state of being designed for, tuned for, trained for, tailored to, optimized for, oriented toward, or associated with performance of one or more particular machine learning tasks (or types of machine learning tasks) and/or solving one or more particular problems such as, by way of non-limiting example, image classification, sentiment analysis, speech recognition, recommendation generation, object detection, natural language processing, clustering, and/or others. Different task-specific models may be adapted for performing similar types of machine learning tasks in different domains and/or subspecialties. By way of illustrative example, one task-specific model for image classification may be adapted for classifying medical images, whereas another task-specific model for image classification may be adapted for classifying cellular microscopy images. Task-specific ground truth output may comprise ground truth labels (classifications, predictions, recommendations, cluster definitions, etc.) for a particular type of machine learning task (or type of machine learning task) and/or for a particular type of problem.

As noted above, task- or domain-specific models that are obtained using base models are computationally intensive to train/fine-tune and to run after training. Customers/users often lack sufficient resources (e.g., GPU resources) to efficiently train or run such task- or domain-specific models.

Accelerated transfer learning has arisen to address at least some of the aforementioned challenges. In accelerated transfer learning, common generic models are executed using hardware accelerators (e.g., field-programmable gate arrays (FPGAs), graphics processing units (GPUs), etc.) and are used as featurizers for task-specific models. Such common generic models that are configured for execution using one or more hardware accelerators are referred to herein as “accelerated machine learning models” or “accelerated models.” In one example, a hardware-accelerated generic model generates embeddings that are utilized to train a task-specific model (or many task-specific models suited to different tasks). At inference, the hardware-accelerated generic model receives input and then outputs embeddings that are used as input to the task-specific model, and the task-specific model generates a final output. Multiple different task-specific models may be trained for us in conjunction with a single common generic model. The single common generic model may comprise a shared resource, especially when task-specific model functionality is implemented in constrained/low-resources environments. Utilization of a common generic model as a shared resource may lead to cost reductions and/or savings.

Under such a framework, the size and/or complexity of task-specific models can be significantly reduced, enabling the task-specific models to be trained and/or run on customer/user computing systems (e.g., CPU resources) that are remote from hardware accelerators associated with the generic models.

Although an accelerated transfer learning framework can beneficially allow customers/users to train and/or run task-specific models using their own computational resources (e.g., for use in conjunction with hardware-accelerated common generic models), various technical problems associated with accelerated transfer learning exist. For instance, by only fine-tuning the task-specific portion of an overall model structure (e.g., where the overall model structure includes the common generic model and the task-specific model), it is possible that performance of the overall model structure may be negatively affected.

Another technical problem associated with accelerated transfer learning is that different models for different use cases may perform best with different model architectures (e.g., different layer configurations, types, quantities, etc.), and owners of task-specific models in an accelerated transfer learning framework may find it difficult, or lack the expertise or experimentation capabilities, to design model components to be competitive with fully fine-tuned models (e.g., models that do not rely on transfer learning). For instance, users may lack the expertise to appropriately configure transfer learning settings, model layer configurations, parameter/representation settings, etc.

The present disclosure includes various technical solutions that may be applied to solve at least some of the aforementioned technical problems. In at least some disclosed embodiments, such technical solutions involve utilizing model architecture search (e.g., neural architecture search (NAS) and/or other techniques) to design task-specific components/models in a manner that improves transfer learning between a hardware-accelerated base generic pre-trained model and task-specific models. In one example, a system is configured to perform NAS using a selected search space to determine candidate model architectures. The system then uses the candidate model architectures to train candidate task-specific models using task-specific ground truth and embedding output from a hardware-accelerated common generic pre-trained model. The system then evaluates performance of the candidate task-specific models to select/output one or more (final) task-specific machine learning models for inference use in conjunction with the hardware-accelerated common generic pre-trained model.

In some implementations, the candidate model architectures are retained for future use (e.g., in a task-specific model store) such as use as a starting point to construct candidate task-specific models for novel use cases.

One technical effect of application of the foregoing techniques is the generation of one or more machine learning models that include a model architecture (obtained via NAS) that is automatically tuned for use in transfer learning/inference implementations via optimization using embedding output of an accelerated machine learning model. Implementation of the disclosed embodiments can enable customers/users to obtain task-specific models for transfer learning settings with minimal technical expertise and/or expenditure. In at least some instances, task-specific models generated according to the principles disclosed herein perform as well as or better than fully fine-tuned models.

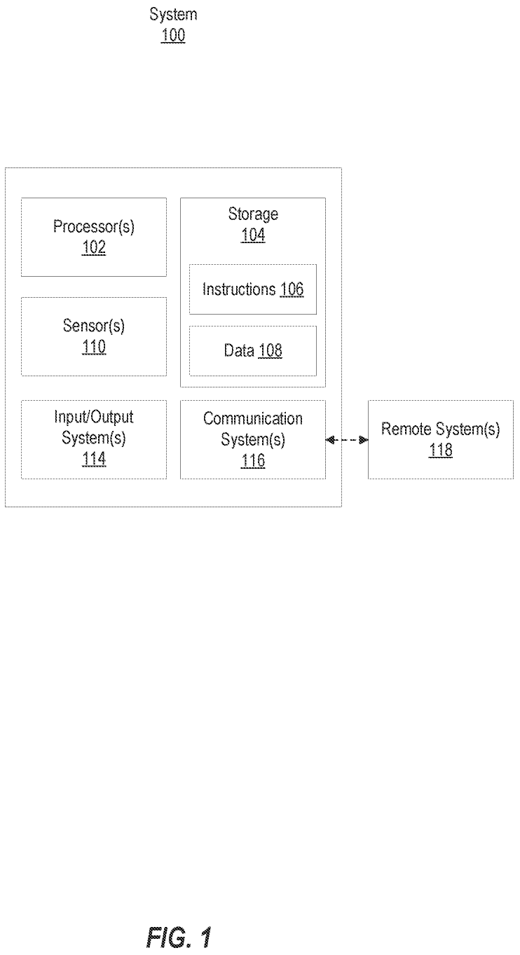

Having just described some of the various high-level features and benefits associated with the disclosed embodiments, attention will now be directed to FIGS. 1 through 6 These Figures illustrate various conceptual representations, architectures, methods, and supporting illustrations related to the disclosed embodiments.

### Example Systems and Components

FIG. 1 illustrates various example components of a system 100 that may be used to implement one or more disclosed embodiments. For example, FIG. 1 illustrates that a system 100 may include processor(s) 102, storage 104, sensor(s) 110, input/output system(s) 114 (I/O system(s) 114), and communication system(s) 116. Although FIG. 1 illustrates a system 100 as including particular components, one will appreciate, in view of the present disclosure, that a system 100 may comprise any number of additional or alternative components.

The processor(s) 102 may comprise one or more sets of electronic circuitries that include any number of logic units, registers, and/or control units to facilitate the execution of computer-readable instructions (e.g., instructions that form a computer program). Processor(s) 102 may take on various forms, such as, by way of non-limiting example, Field-programmable Gate Arrays (FPGAs), application-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

Computer-readable instructions may be stored within storage 104. The storage 104 may comprise physical system memory and may be volatile, non-volatile, or some combination thereof. Furthermore, storage 104 may comprise local storage, remote storage (e.g., accessible via communication system(s) 116 or otherwise), or some combination thereof. Additional details related to processors (e.g., processor(s) 102) and computer storage media (e.g., storage 104) will be provided hereinafter.

In some implementations, the processor(s) 102 may comprise or be configurable to execute any combination of software and/or hardware components that are operable to facilitate processing using machine learning models or other artificial intelligence-based structures/architectures. For example, processor(s) 102 may comprise and/or utilize hardware components or computer-executable instructions operable to carry out function blocks and/or processing layers configured in the form of, by way of non-limiting example, fully connected layers, convolutional layers, pooling layers, recurrent layers, embedding layers, dropout layers, normalization layers, attention layers, transformer layers, flatten layers, and/or others without limitation.

As will be described in more detail, the processor(s) 102 may be configured to execute instructions 106 stored within storage 104 to perform certain actions. The actions may rely at least in part on data 108 stored on storage 104 in a volatile or non-volatile manner.

In some instances, the actions may rely at least in part on communication system(s) 116 for receiving data from remote system(s) 118, which may include, for example, separate systems or computing devices, sensors, and/or others. The communications system(s) 116 may comprise any combination of software or hardware components that are operable to facilitate communication between on-system components/devices and/or with off-system components/devices. For example, the communications system(s) 116 may comprise ports, buses, or other physical connection apparatuses for communicating with other devices/components. Additionally, or alternatively, the communications system(s) 116 may comprise systems/components operable to communicate wirelessly with external systems and/or devices through any suitable communication channel(s), such as, by way of non-limiting example, Bluetooth, ultra-wideband, WLAN, infrared communication, and/or others.

FIG. 1 illustrates that a system 100 may comprise or be in communication with sensor(s) 110. Sensor(s) 110 may comprise any device for capturing or measuring data representative of perceivable or detectable phenomena. By way of non-limiting example, the sensor(s) 110 may comprise one or more radar sensors, image sensors, microphones, thermometers, barometers, magnetometers, accelerometers, gyroscopes, and/or others.

Furthermore, FIG. 1 illustrates that a system 100 may comprise or be in communication with I/O system(s) 114. I/O system(s) 114 may include any type of input or output device such as, by way of non-limiting example, a touch screen, a mouse, a keyboard, a controller, and/or others, without limitation. For example, the I/O system(s) 114 may include a display system that may comprise any number of display panels, optics, laser scanning display assemblies, and/or other components.

At least some components of the system 100 may comprise or utilize various types of devices, such as mobile electronic devices (e.g., smartphones), personal computing devices (e.g., a laptops), wearable devices (e.g., smartwatches, HMDs, etc.), vehicles (e.g., aerial vehicles, autonomous vehicles, etc.), and/or other devices. A system 100 may take on other forms in accordance with the present disclosure.

### Model Architecture Generation for Task-Specific Models

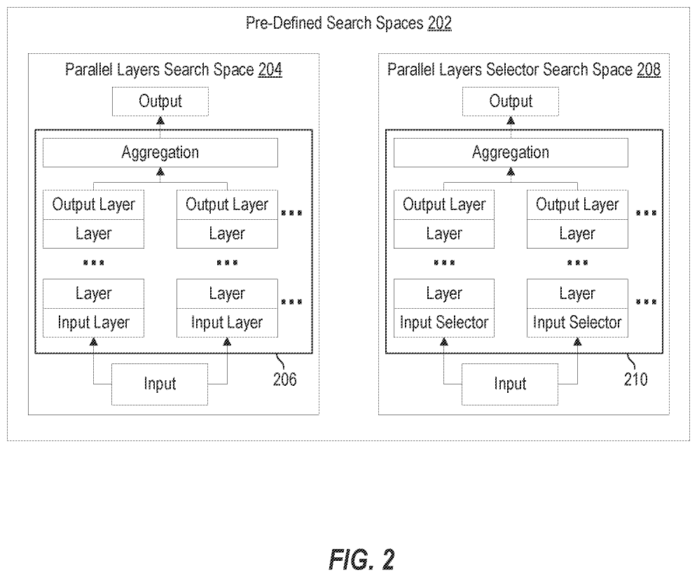

As noted above, disclosed embodiments utilize NAS to facilitate generation of candidate model architectures for task-specific models in a transfer learning framework. FIG. 2 depicts example search spaces that may be utilized to generate such candidate model architectures via NAS. In particular, FIG. 2 illustrates pre-defined search spaces 202, which includes two example search spaces that may be utilized to facilitate neural architecture via NAS in accordance with implementations of the present disclosure. Each search space within the pre-defined search spaces 202 defines possible model architectures that can be generated or considered by a NAS algorithm. Each search space within the pre-defined search spaces 202 comprises a set of possible combinations of model components or operations, such as convolutional layers, pooling layers, skip connections, and/or other components that can be used to construct a model (e.g., a neural network).

The search spaces of the predefined search spaces 202 may be defined by quantities of layers, types of layers, layer connectivity, and/or other hyperparameters such as kernel size, stride, activation functions, etc. Some example types of layers that may be included in the search spaces are fully connected layers, convolutional layers, pooling layers, recurrent layers, embedding layers, dropout layers, normalization layers, attention layers, transformer layers, flatten layers, and/or others without limitation.

In the example of FIG. 2, the pre-defined search spaces 202 include a parallel layers search space 204 and a parallel layers selector search space 208. FIG. 2 depicts the parallel layers search space 204 and the parallel layers selector search space 208 as including various model components (within boxes 206 and 210, respectively) that may be used to form models that are configurable to receive an input and generate an output. Within the context of transfer learning, the input may comprise embeddings provided by a hardware-accelerated base generic model, and the output may comprise a task-specific output.

In the example of FIG. 2, the parallel layers search space 204 includes architectures with one or more sets of parallel layers (or streams), where each stream includes any number of layers. The example of FIG. 2 depicts two streams side-by-side, with each stream including an input layer, an output layer, and two intervening layers. The ellipses shown in FIG. 2 within the parallel layers search space 204 indicate that model architectures defined in accordance with the parallel layers search space 204 may comprise any number of streams (e.g., one or more), and each stream can include any number of layers.

FIG. 2 also depicts that the parallel layers search space 204 includes an aggregation component, which may be configured to aggregate output of the various streams of a model constructed according to the parallel layers search space 204. The aggregation component may aggregate outputs from the output layers of the various streams in any suitable manner, such as, by way of non-limiting example, summation, averaging, grouping, counting, ranking/percentiles, concatenation, clustering, crosstabulation, aggregation with a function, combinations thereof, and/or others.

The parallel layers selector search space 208 is similar to the parallel layers search space in that the parallel layers selector search space 208 includes architectures with one or more sets of parallel layers (or streams), where each stream includes any number of layers. The parallel layers selector search space 208 also includes an aggregation component for aggregating outputs of the various streams. As depicted in FIG. 2, streams of model architectures defined according to the parallel layers selector search space 208 include an input selector. As noted above, the input provided to models with architectures defined in accordance with the pre-defined search spaces 202 may comprise embeddings output by accelerated machine learning model. The input selector is configurable to select hidden outputs and/or intermediate values/representations generated by the accelerated machine learning model during computation of the embeddings.

The input selector may sample from the hidden outputs of the accelerated machine learning model in any suitable manner (e.g., random sampling, weighted sampling, sampling from pre-defined components, etc.) and may select any number or type of hidden outputs. By way of non-limiting example, hidden outputs that may be selected by the input selector may comprise activations, node decisions, feature values, support vectors, intermediate embeddings, hidden or other states, weights (e.g., attention weights), and/or others.

It has been found that utilizing a parallel layers search space 204 or a parallel layers selector search space 208 to perform NAS to generate candidate model architectures for task-specific models in a transfer learning framework can produce task-specific models (for use in conjunction with an common generic model) that achieve comparable or improved performance relative to fully fine-tuned networks. Notwithstanding, it will be appreciated, in view of the present disclosure, that the parallel layers search space 204 and the parallel layers selector search space 208 are provided by way of example only and are not limiting of the principles described herein. Accordingly, the pre-defined search spaces 202 may comprise additional or alternative search spaces for performing NAS to generate candidate model architectures.

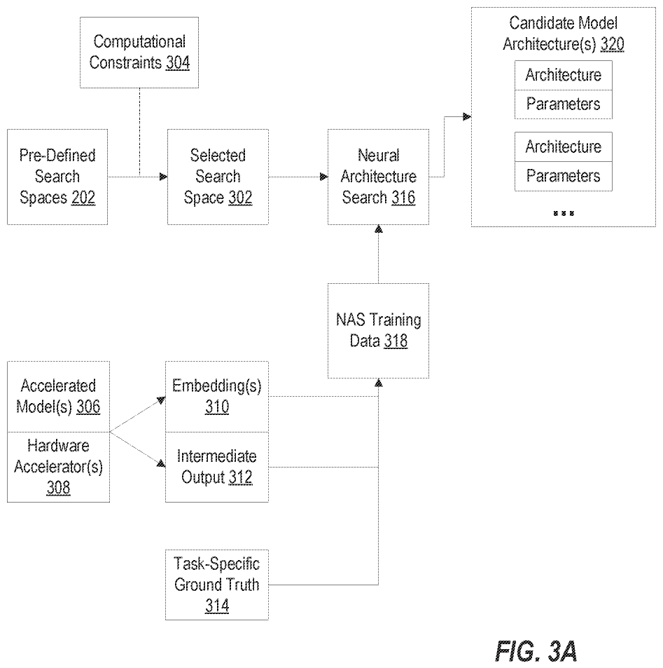

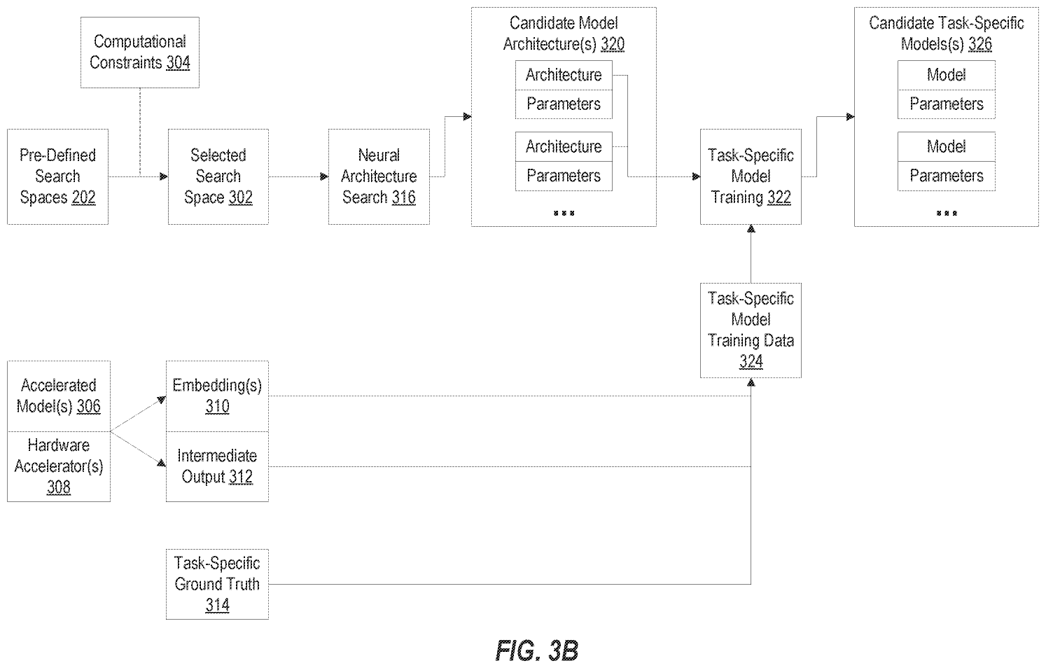

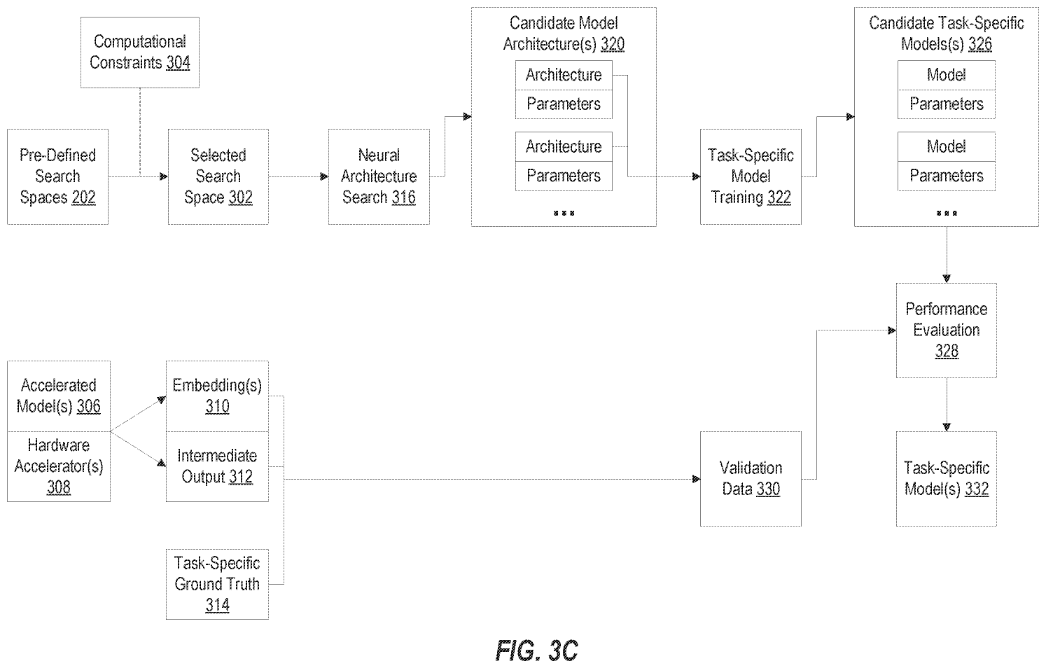

FIG. 3A depicts a conceptual representation of utilizing NAS to generate candidate model architectures for task-specific models in accelerated transfer learning. FIG. 3A includes a representation of the pre-defined search spaces 202 described hereinabove with reference to FIG. 2. FIG. 3A also illustrates a selected search space 302 that is selected from the pre-defined search spaces 202. For example, the selected search space 302 may comprise a parallel layers search space 204 or a parallel layers selector search space 208. The selected search space 302 may be selected based on various factors, such as computational constraints 304, desired training/processing time, and/or others.

The selected search space 302 comprises a set of possible combinations of model components or operations that can be used to construct a model (e.g., a neural network). FIG. 3A depicts the selected search space 302 being used in neural architecture search 316 to generate candidate model architectures 320. The neural architecture search 316 may be performed in accordance with any suitable NAS framework, such as, by way of non-limiting example, reinforcement learning based NAS, evolutionary NAS, gradient-based NAS, Bayesian optimization based NAS, random search NAS, one-shot NAS, hierarchical NAS, multi-objective optimization NAS, meta-learning based NAS, and/or others.

The neural architecture search 316 may comprise generating a set of initial candidate model architectures by sampling from the selected search space 302 (in accordance with any suitable sampling technique). In some instances, the neural architecture search 316 further includes training the individual architectures of the set of initial candidate model architectures using NAS training data 318. In the example of FIG. 3A, the NAS training data 318 includes (or is sampled from) embeddings 310, intermediate output 312, and/or task-specific ground truth 314. The embeddings 310 and the intermediate output 312 of FIG. 3A are generated by one or more accelerated models 306 that are configured for execution using one or more hardware accelerators 308. The accelerated models 306 may comprise one or more base generic models configured to generate embeddings (and/or intermediate output) for use in conjunction with task-specific models in transfer learning and inference applications. The hardware accelerators 308 may comprise, by way of non-limiting example, FPGAs, GPUs, tensor processing units (TPUs), ASICs, and/or others.

The task-specific ground truth 314 comprise task-specific labels, classifications, predictions, and/or other ground truth output that task-specific models constructed based on the candidate model architectures 320 are desired to learn (e.g., to enable the task-specific models to generalize at inference). In some instances, the intermediate output 312 is omitted from the NAS training data 318, such as when the selected search space 302 does not rely on intermediate outputs (e.g., when the selected search space 302 comprises a parallel layers search space 204, or another search space that omits an input selector).

In the example of FIG. 3A, after training of the set of initial candidate model architectures using the NAS training data 318, the neural architecture search 316 includes evaluating performance of the trained set of initial candidate model architectures. The performance evaluation may comprise an evaluation of any suitable model performance metrics (e.g., related to the specific task), such as, by way of non-limiting example, accuracy, precision, recall, mean squared error, mean absolute error, and/or others. Model architectures of the set of initial candidate model architectures that satisfy the performance metrics are included in the candidate model architectures 320.

As shown in FIG. 3A, each architecture of the candidate model architectures 320 acquires parameters (e.g., weights) throughout the neural architecture search 316. The model architectures of the candidate model architectures 320 may be utilized to generate task-specific models for use in conjunction with accelerated models (e.g., in transfer learning and/or inference).

FIG. 3B depicts a conceptual representation of using the candidate model architectures 320 to train candidate task-specific models 326 for accelerated transfer learning and/or inference. FIG. 3B conceptually depicts task-specific model training 322, in which a set of task-specific models with model architectures obtained from the candidate model architectures 320 are trained using task-specific model training data 324. In some implementations, as shown in FIG. 3B, the task-specific model training 322 to obtain the candidate task-specific models 326 refrains from utilizing the parameters/weights associated with the architectures from the candidate model architectures 320. Instead, such parameters/weights associated with the architectures of the candidate model architectures 320 may be discarded, and new parameters/weights may be trained for the candidate task-specific models 326 (as depicted in FIG. 3B by the parameters associated with each model of the candidate task-specific models 326). In some instances, training new parameters/weights for the candidate task-specific models 326 may contribute to improved generalization/performance on the applicable task.

As noted above, the task-specific model training 322 may utilize task-specific model training data 324 to generate the candidate task-specific models 326. In some implementations, similar to the NAS training data 318, the task-specific model training data 324 includes (or is sampled from) embeddings 310, intermediate output 312, and/or task-specific ground truth 314, where the embeddings 310 and the intermediate output 312 (e.g., used as input data of the task-specific model training data 324) are generated by one or more accelerated models 306 that are configured for execution using one or more hardware accelerators 308. In some implementations, the task-specific model training data 324 and the NAS training data 318 are sampled from the same set of training data (or comprise the same set of training data). The task-specific ground truth 314 comprise task-specific labels, classifications, predictions, and/or other ground truth output that the candidate task-specific models are desired to learn (e.g., to enable the task-specific models to generalize at inference). In some instances, the intermediate output 312 is omitted from the task-specific model training data 324, such as when the architectures of the candidate model architectures 320 do not rely on intermediate outputs (e.g., when the selected search space 302 comprises a parallel layers search space 204, or another search space that omits an input selector).

As shown in FIG. 3B, each model of the candidate task-specific models 326 acquires parameters (e.g., weights) throughout the task-specific model training 322. In the example of FIG. 3C, after training of candidate task-specific models 326, a system implements performance evaluation 328 on the candidate task-specific models 326 to determine one or more final task-specific models 332. The performance evaluation 328 may comprise an evaluation of any suitable model performance metrics, such as, by way of non-limiting example, accuracy, precision, recall, mean squared error, mean absolute error, and/or others. In the example of FIG. 3C, the performance evaluation 328 of the candidate task-specific models 326 may utilize validation data 330. As shown in FIG. 3C, the validation data 330 may include (or be sampled from) embeddings 310, intermediate output 312, and/or task-specific ground truth 314. In some implementations, the validation data 330 is sampled from the same set of training data as the task-specific model training data 324 and/or the NAS training data 318.

The final task-specific model(s) 332 may be selected/output based upon the performance evaluation 328 (e.g., based upon performance metrics exhibited by the candidate task-specific models 326). As noted hereinabove, the task-specific model(s) 332 are usable in conjunction with an accelerated machine learning model (executed on a hardware accelerator system) to facilitate performance of tasks/operations. The task-specific model(s) 332 may advantageously be executed on computing resources (e.g., GPU and/or CPU resources) that are remote from the hardware accelerator(s) used to execute the accelerated machine learning model. Such functionality may beneficially enable the task-specific model(s) 332 to operate in resource constrained/limited environments, while the common generic model (the accelerated machine learning model) is a shared resource.

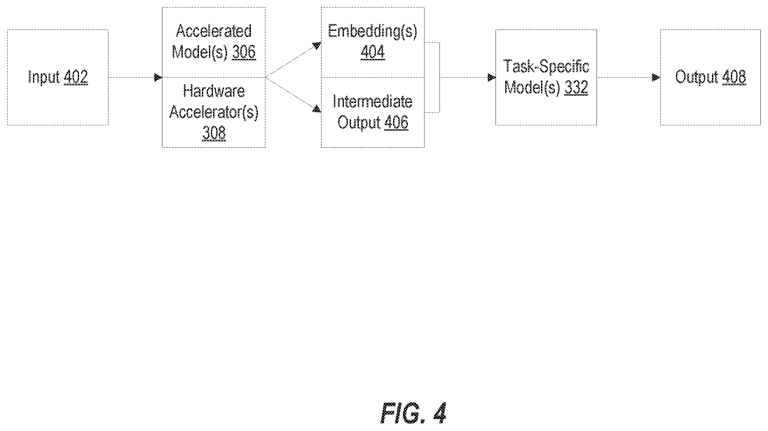

FIG. 4 depicts a conceptual representation of operation of the task-specific model(s) 332 in conjunction with accelerated model(s) 306 to perform inference tasks. FIG. 4 depicts an input 402 provided to the accelerated model(s) 306 executed on the hardware accelerator(s) 308. The accelerated model(s) 306 generate embedding(s) 404 that are used as input to the task-specific model(s) 332. In some instances, intermediate output 406 generated by the accelerated model(s) 306 to compute the embedding(s) 404 is/are also utilized as input to the task-specific model(s) 332. The task-specific model(s) 332 process the embedding(s) 404 (and/or intermediate output 406) to generate output 408, which may comprise task-specific output.

As noted above, accelerated model(s) 306 may comprise a generic or common base model that is usable to provide embeddings that may be processed by different task-specific models (executable on different processing systems) to perform different tasks. For example, the accelerated model(s) 306 may comprise generic components of an NLR, and multiple different task-specific models may comprise task- or domain-specific components for facilitating natural language processing. For instance, the same base or generic accelerated NLR model may generate embeddings usable by different task-specific NLR models for different domains (e.g., a medicine domain, an engineering domain, a psychology domain, etc.).

### Example Method(s)

The following discussion now refers to a number of methods and method acts that may be performed in accordance with the present disclosure. Although the method acts are discussed in a certain order and illustrated in a flow chart as occurring in a particular order, no particular ordering is required unless specifically stated, or required because an act is dependent on another act being completed prior to the act being performed. One will appreciate that certain embodiments of the present disclosure may omit one or more of the acts described herein.

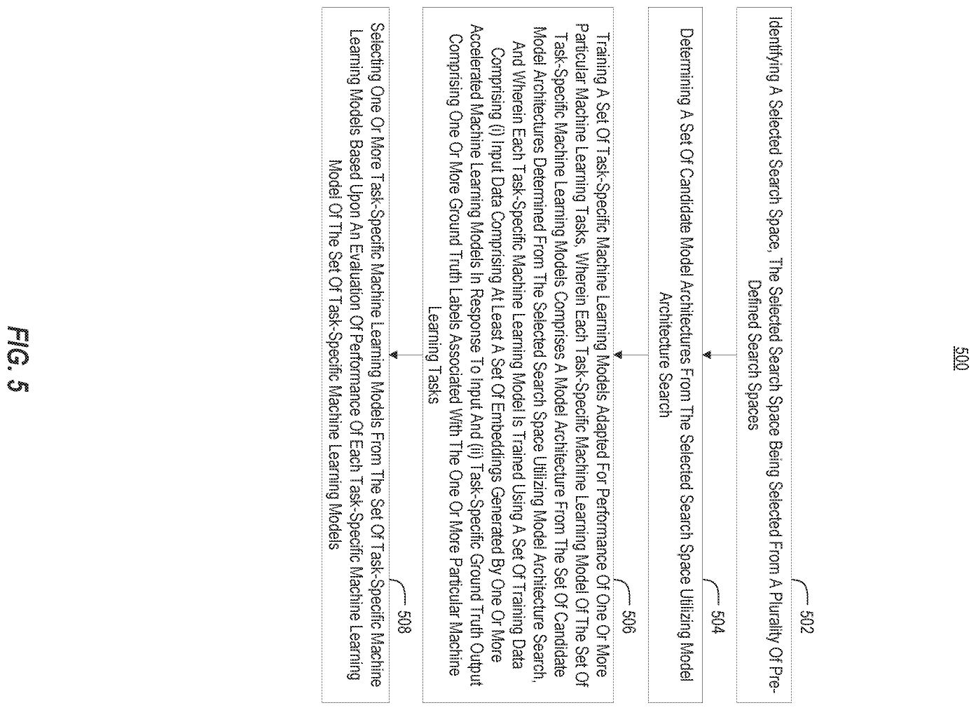

FIG. 5 illustrates an example flow diagram 500 depicting acts associated with generating one or more task-specific machine learning models for use in conjunction with one or more accelerated machine learning models.

Act 502 of flow diagram 500 includes identifying a selected search space, the selected search space being selected from a plurality of pre-defined search spaces. In some instances, the plurality of pre-defined search spaces comprises at least (i) a parallel layers search space and (ii) a parallel layers selector search space. In some implementations, the selected search space is selected based upon one or more computational constraints.

Act 504 of flow diagram 500 includes determining a set of candidate model architectures from the selected search space utilizing model architecture search. In some examples, determining the set of candidate model architectures comprises utilizing a NAS framework. In some implementations, determining the set of candidate model architectures includes: (i) generating a set of initial candidate model architectures by sampling from the selected search space; (ii) training initial candidate model architectures of the set of initial candidate model architectures using a set of NAS training data; (iii) evaluating whether each of the initial candidate model architectures of the set of initial candidate model architectures satisfies one or more performance metrics; and (iv) defining the set of candidate model architectures as the initial candidate model architectures of the set of initial candidate model architectures that satisfy the one or more performance metrics. In some implementations, the set of NAS training data comprises (i) input data generated by the one or more accelerated machine learning models and (ii) task-specific ground truth output. In some examples, the input data of the set of NAS training data comprises intermediate output generated by the one or more accelerated machine learning models when the selected search space comprises a parallel layers selector search space. In some instances, determining the set of candidate model architectures comprises generating a set of weights for each candidate model architecture of the set of candidate model architectures.

Act 506 of flow diagram 500 includes training a set of task-specific machine learning models adapted for performance of one or more particular machine learning tasks, wherein each task-specific machine learning model of the set of task-specific machine learning models comprises a model architecture from the set of candidate model architectures determined from the selected search space utilizing NAS, and wherein each task-specific machine learning model is trained using a set of training data comprising (i) input data comprising at least a set of embeddings generated by one or more accelerated machine learning models in response to input and (ii) task-specific ground truth output comprising one or more ground truth labels associated with the one or more particular machine learning tasks. In some implementations, the one or more accelerated machine learning models are configured to be executed on one or more hardware accelerators. In some examples, the one or more hardware accelerators comprise one or more field-programmable gate arrays (FPGAs), graphics processing units (GPUs), tensor processing units (TPUs), or application-specific integrated circuits (ASICs). In some instances, when the selected search space comprises the parallel layers selector search space, the input data further comprises intermediate output generated by the one or more accelerated machine learning models. In some implementations, training the set of task-specific machine learning models based upon the set of candidate model architectures comprises refraining from using the set of weights for each candidate model architecture of the set of candidate model architectures (e.g., a system may discard the set of weights for each candidate model architecture of the set of candidate model architectures).

Act 508 of flow diagram 500 includes selecting one or more task-specific machine learning models from the set of task-specific machine learning models based upon an evaluation of performance of each task-specific machine learning model of the set of task-specific machine learning models. In some examples, the one or more task-specific machine learning models are configured for execution on a CPU system. In some instances, the evaluation of performance of each task-specific machine learning model of the set of task-specific machine learning models utilizes a set of validation data, wherein the set of validation data comprises (i) input data generated by the one or more accelerated machine learning models and (ii) task-specific ground truth output.

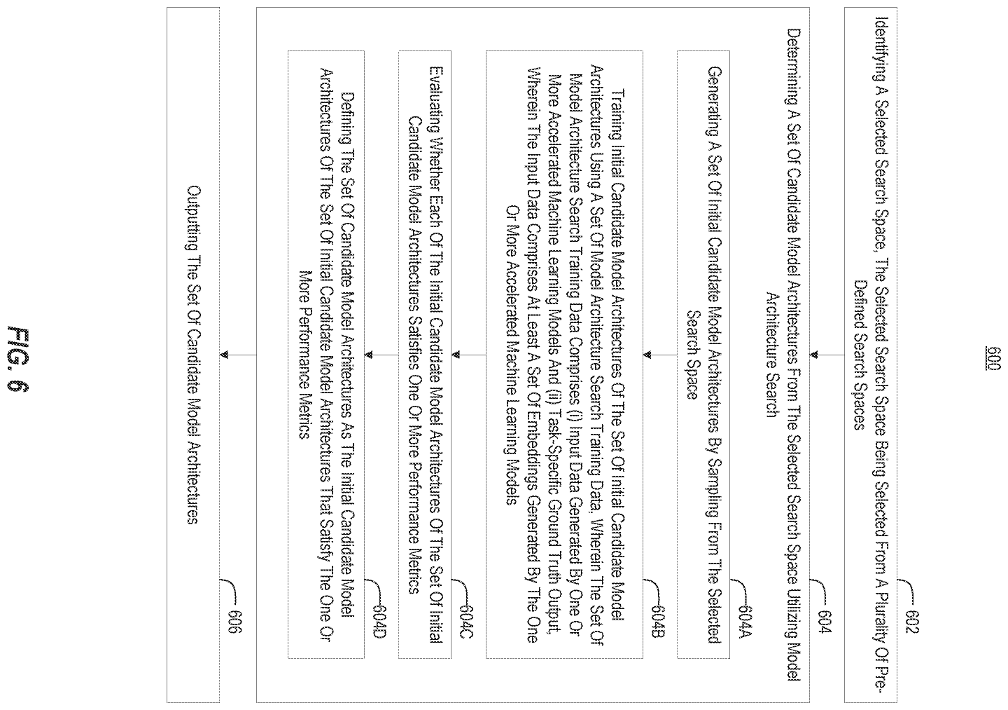

FIG. 6 illustrates an example flow diagram 600 depicting acts associated with generating a set of model architectures for a task-specific machine learning model for use in conjunction with an accelerated machine learning model.

Act 602 of flow diagram 600 includes identifying a selected search space, the selected search space being selected from a plurality of pre-defined search spaces.

Act 604 of flow diagram 600 includes determining a set of candidate model architectures from the selected search space utilizing model architecture search. In flow diagram 600, act 604 includes various steps. Step 604A includes generating a set of initial candidate model architectures by sampling from the selected search space. Step 604B includes training initial candidate model architectures of the set of initial candidate model architectures using a set of NAS training data, wherein the set of NAS training data comprises (i) input data generated by one or more accelerated machine learning models and (ii) task-specific ground truth output, wherein the input data comprises at least a set of embeddings generated by the one or more accelerated machine learning models. Step 604C includes evaluating whether each of the initial candidate model architectures of the set of initial candidate model architectures satisfies one or more performance metrics. Step 604D includes defining the set of candidate model architectures as the initial candidate model architectures of the set of initial candidate model architectures that satisfy the one or more performance metrics.

Act 606 of flow diagram 600 includes outputting the set of candidate model architectures.

### Additional Details Related to the Disclosed Embodiments

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are one or more “physical computer storage media” or “hardware storage device(s).” Computer-readable media that merely carry computer-executable instructions without storing the computer-executable instructions are “transmission media.” Thus, by way of example and not limitation, the current embodiments can comprise at least two different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in hardware in the form of computer-executable instructions, data, or data structures and that can be accessed by a general-purpose or special-purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry program code in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Disclosed embodiments may comprise or utilize cloud computing. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAS, pagers, routers, switches, wearable devices, and the like. The invention may also be practiced in distributed system environments where multiple computer systems (e.g., local and remote systems), which are linked through a network (either by hardwired data links, wireless data links, or by a combination of hardwired and wireless data links), perform tasks. In a distributed system environment, program modules may be located in local and/or remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

As used herein, the terms “executable module,” “executable component,” “component,” “module,” or “engine” can refer to hardware processing units or to software objects, routines, or methods that may be executed on one or more computer systems. The different components, modules, engines, and services described herein may be implemented as objects or processors that execute on one or more computer systems (e.g., as separate threads).

One will also appreciate how any feature or operation disclosed herein may be combined with any one or combination of the other features and operations disclosed herein. Additionally, the content or feature in any one of the figures may be combined or used in connection with any content or feature used in any of the other figures. In this regard, the content disclosed in any one figure is not mutually exclusive and instead may be combinable with the content from any of the other figures.

As used herein, the term “about”, when used to modify a numerical value or range, refers to any value within 5%, 10%, 15%, 20%, or 25% of the numerical value modified by the term “about”.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope

I claim:

1. A system for generating one or more task-specific machine learning models for use in conjunction with one or more accelerated machine learning models configured for execution on one or more hardware accelerators, the system comprising:
one or more processors; and
one or more hardware storage devices that store instructions that are executable by the one or more processors to configure the system to:
identify a selected search space, the selected search space being selected from a plurality of pre-defined search spaces;
determine a set of candidate model architectures from the selected search space utilizing model architecture search;
train a set of task-specific machine learning models adapted for performance of one or more particular machine learning tasks, wherein each task-specific machine learning model of the set of task-specific machine learning models comprises a model architecture from the set of candidate model architectures determined from the selected search space utilizing model architecture search, and wherein each task-specific machine learning model is trained using a set of training data comprising (i) input data comprising at least a set of embeddings generated by one or more accelerated machine learning models in response to input, and (ii) task-specific ground truth output comprising one or more ground truth labels associated with the one or more particular machine learning tasks; and
select one or more task-specific machine learning models from the trained set of task-specific machine learning models based upon an evaluation of performance of each trained task-specific machine learning model of the trained set of task-specific machine learning models.

2. The system of claim 1, wherein the instructions are executable by the one or more processors to further configure the system to:
receive a set of input embeddings generated by the one or more accelerated machine learning models; and
generate task-specific output by utilizing the set of input embeddings as input to the one or more task-specific machine learning models.

3. The system of claim 1, wherein the one or more accelerated machine learning models are configured to be executed on one or more hardware accelerators.

4. The system of claim 3, wherein the one or more hardware accelerators comprise one or more field-programmable gate arrays (FPGAs), graphics processing units (GPUs), tensor processing units (TPUs), or application-specific integrated circuits (ASICs).

5. The system of claim 1, wherein the plurality of pre-defined search spaces comprises at least (i) a parallel layers search space and (ii) a parallel layers selector search space.

6. The system of claim 1, wherein the selected search space is selected based upon one or more computational constraints.

7. The system of claim 5, wherein, when the selected search space comprises the parallel layers selector search space, the input data further comprises intermediate output generated by the one or more accelerated machine learning models.

8. The system of claim 1, wherein determining the set of candidate model architectures comprises utilizing a neural architecture search framework.

9. The system of claim 8, wherein determining the set of candidate model architectures comprises:
generating a set of initial candidate model architectures by sampling from the selected search space;
training initial candidate model architectures of the set of initial candidate model architectures using a set of NAS training data;
evaluating whether each of the initial candidate model architectures of the set of initial candidate model architectures satisfies one or more performance metrics; and
defining the set of candidate model architectures as the initial candidate model architectures of the set of initial candidate model architectures that satisfy the one or more performance metrics.

10. The system of claim 9, wherein the set of NAS training data also comprises (i) input data generated by the one or more accelerated machine learning models and (ii) task-specific ground truth output.

11. The system of claim 10, wherein the input data of the set of NAS training data comprises intermediate output generated by the one or more accelerated machine learning models when the selected search space comprises a parallel layers selector search space.

12. The system of claim 9, wherein determining the set of candidate model architectures comprises generating a set of weights for each candidate model architecture of the set of candidate model architectures.

13. The system of claim 12, wherein training the set of task-specific machine learning models based upon the set of candidate model architectures comprises refraining from using the set of weights for each candidate model architecture of the set of candidate model architectures.

14. The system of claim 1, wherein the evaluation of performance of each task-specific machine learning model of the set of task-specific machine learning models utilizes a set of validation data, wherein the set of validation data also comprises (i) input data generated by the one or more accelerated machine learning models and (ii) task-specific ground truth output.

15. A system for generating a set of model architectures for a task-specific machine learning model for use in conjunction with an accelerated machine learning model, the system comprising:
one or more processors; and
one or more hardware storage devices that store instructions that are executable by the one or more processors to configure the system to:
identify a selected search space, the selected search space being selected from a plurality of pre-defined search spaces;
determine a set of candidate model architectures from the selected search space utilizing model architecture search, wherein determining the set of candidate model architectures comprises:
generating a set of initial candidate model architectures by sampling from the selected search space;
training initial candidate model architectures of the set of initial candidate model architectures using a set of model architecture search training data, wherein the set of model architecture search training data comprises (i) input data generated by one or more accelerated machine learning models and (ii) task-specific ground truth output, wherein the input data comprises at least a set of embeddings generated by the one or more accelerated machine learning models;
evaluating whether each of the initial candidate model architectures of the set of initial candidate model architectures satisfies one or more performance metrics; and
defining the set of candidate model architectures as the initial candidate model architectures of the set of initial candidate model architectures that satisfy the one or more performance metrics; and
output the set of candidate model architectures.

16. The system of claim 15, wherein the one or more accelerated machine learning models are configured to be executed on one or more hardware accelerators.

17. The system of claim 15, wherein the plurality of pre-defined search spaces comprises at least (i) a parallel layers search space and (ii) an parallel layers selector search space.

18. The system of claim 15, wherein determining the set of candidate model architectures further comprises generating a set of weights for each candidate model architecture of the set of candidate model architectures.

19. The system of claim 18, wherein the instructions are executable by the one or more processors to further configure the system to discard the set of weights for each candidate model architecture of the set of candidate model architectures.

20. A system for generating one or more task-specific machine learning models for use in conjunction with one or more accelerated machine learning models, the system comprising:
one or more processors; and
one or more hardware storage devices that store instructions that are executable by the one or more processors to configure the system to:
access a set of candidate model architectures, the set of candidate model architectures being generated by:
identifying a selected search space, the selected search space being selected from a plurality of pre-defined search spaces; and
determining the set of candidate model architectures from the selected search space utilizing model architecture search;
train a set of task-specific machine learning models based upon the set of candidate model architectures, wherein each task-specific machine learning model comprises a model architecture from the set of candidate model architectures, and wherein each task-specific machine learning model is trained using a set of training data comprising (i) input data generated by one or more accelerated machine learning models and (ii) task-specific ground truth output, wherein the input data comprises at least a set of embeddings generated by the one or more accelerated machine learning models; and
output one or more task-specific machine learning models from the set of task-specific machine learning models based upon an evaluation of performance of each task-specific machine learning model of the set of task-specific machine learning models.
